(19) United States
(12) Patent Application Publication
(10) Pub. No.: US 2023/0034305 A1
(43) Pub. Date: Feb. 2, 2023

(54) STEAM DIRECTIONAL CONDENSATION STRUCTURE OF LID

(71) Applicant: Winnington Metal & Plastic Manufacturing Company Limited, Cheung Sha Wan (HK)

(72) Inventor: Chiu Hung Chan, Cheung Sha Wan (HK)

(21) Appl. No.: 17/390,045

(22) Filed: Jul. 30, 2021

(51) Int. Cl. A47J 36/06; A47J 36/38

(52) U.S. Cl. CPC A47J 36/06; A47J 36/38

(57) ABSTRACT

Steam directional condensation structure of cover body, wherein he internal side of the lid provides with a curved groove surface for generating steam vortex; along the section of the protrusion part, a protrusion part is provided at one side for conducting the condense droplet back to the cookware. Because the curvature of the curved groove surface is greater than that of the inner surface of the lid, the water in the cookware boils to produce a large amount of steam the steam will form a vortex in the curved groove surface, so that the steam can fully contact the curved groove surface to condense, and at the same time, after condensation the water flows to the protrusion part driven by the vortex, and finally drips back into the cookware along the protrusion part. The curved groove surface and the protrusion part are set to appropriate positions according to the needs of use.

### FIELD OF THE INVENTION

The invention involves the structure of a cookware, especially a lid structure which is capable of realizing directional condensation of steam inside.

### BACKGROUND OF THE INVENTION

Cookware generates a lot of steam during the cooking process, especially steamed food. At present, the lid of cookware is not specially designed to collect steam. The steam flows to the edge after condensing on the inner wall of the lid and pushes the lid up to exhaust, the condensed water on the edge will splash out to make the cookware and stove dirty. On the market, some cookware lids provide convex rings added to the inner wall of the lid to prevent steam condensing and flowing to the edge. And some lids have bumps to accelerate the condensation of steam at the bumps and drip back into the cookware. But during the actual cooking process, such as steaming or stewing food, sometimes user hopes that the steam can condense and drip back into the food to maintain the moisture of the food; sometimes user hopes steam can condense and drip back out of the food while excessive moisture will affect the taste and the sharp of the food. The existing steam directional condensation structure is difficult to meet the above usage requirements.

### SUMMARY OF THE INVENTION

In view of the aforesaid drawbacks of the prior art, the present invention provides a cooker lid structure to effectively control the directional condensation of water vapor for meeting different cooking requirements.

Steam directional condensation structure of lid, wherein the internal side of the lid provides with a curved groove surface for generating steam vortex; along the section of the protrusion part, a protrusion part is provided at one side for conducting the condense droplet back to the cookware; when the steam comes into the curved groove surface, it generates the steam vortex and contacts with the curved groove surface to condense into droplets; droplets flow along the curved groove surface to the protrusion part, gather and drip back into the cookware; the curved groove surface and the protrusion part are arranged in the corresponding position of the lid where liquid droplets need to be condensed.

Further, the curvature of each curved groove surface gradually increases from the center of the lid outward along the radial direction.

Further, the curved groove surface is annularly arranged along the radial direction of the lid.

Further, the number of the curved groove surface is two or more; the adjacent curved groove surfaces are connected by protrusion part along the radial direction.

Further, the curved groove surface is also provided with a convex block for guiding the direction of the steam condensation; the convex block is provided with a small diameter end and a large diameter end in lateral direction, the large diameter end faces the center of the lid.

Further, the lateral direction of the convex block is arranged along the radial direction of the lid.

Further, the surface of the small diameter end (5) and the large diameter end (6) is curved.

Further, a number of the convex blocks are evenly arranged in each curved groove surfaces.

Further, the lid is composed of an outer layer and an inner layer, which an insulating interlayer is formed between.

Further, the outer layer and the inner layer are welded as a whole.

The invention has the following advantages: the curvature of the curved groove surface is greater than that of the inner surface of the lid; so When the water in the cookware boils to produce a large amount of steam the steam will form a vortex in the curved groove surface, so that the steam can fully contact the curved groove surface to condense, and at the same time, after condensation the water flows to the protrusion part driven by the vortex, and finally drips back into the cookware along the protrusion part. Therefore, the curved groove surface and the protrusion part can be set to appropriate positions according to directional condense steam to meet different needs during the cooking process.

### BRIEF DESCRIPTION OF THE DRAWINGS

Below are explanations of the invention combining with drawings.

FIG. 1 is the bottom view of the present invention.

FIG. 2 is a section view of the present invention.

FIG. 3 is the zoom view of the curved groove surface.

### DESCRIPTION OF THE EMBODIMENTS

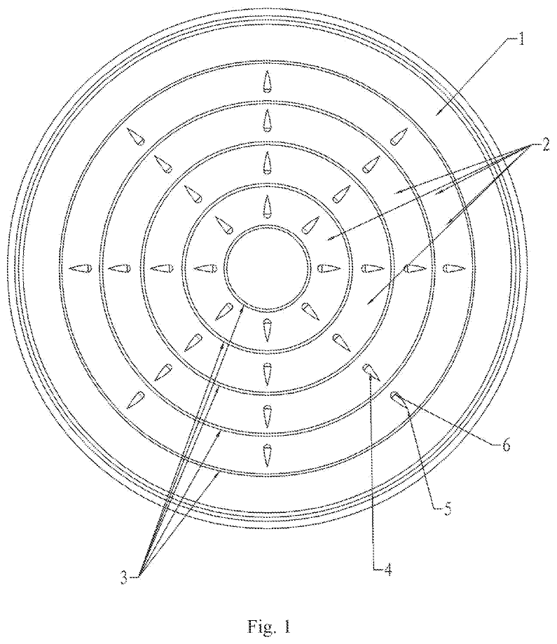

Refer to FIG. 1 and FIG. 2, the steam directional condensation structure of lid 1 provides with a curved groove surface 2 for generating steam vortex; along the section of the protrusion part, a protrusion part 3 is provided at one side for conducting the condense droplet back to the cookware. Because the curvature of the curved groove surface is greater than that of the inner surface of the lid, the water in the cookware boils to produce a large amount of steam the steam will form a vortex in the curved groove surface, so that the steam can fully contact the curved groove surface to condense, and at the same time, after condensation the water flows to the protrusion part driven by the vortex, and finally drips back into the cookware along the protrusion part. The curved groove surface 2 and the protrusion part 3 are set to appropriate positions according to the needs of use. For example, when steaming fish, user may not want the steam to flow back to the steaming tray. Meanwhile, the curved groove surface 2 and the protrusion part 3 are set far from the center, such as close to the edge of the lid 1, so that the steam will condensate and flows to the edges to reduce water dripping back into the steaming tray and prevent the umami taste of the fish from being diluted. On the other hand, if it is desired that the steam can drip back to the food, the curved groove surface 2 and the protrusion part 3 can be arranged near the center. So the directional condensation of stem can meet different usage requirements in the cooking process.

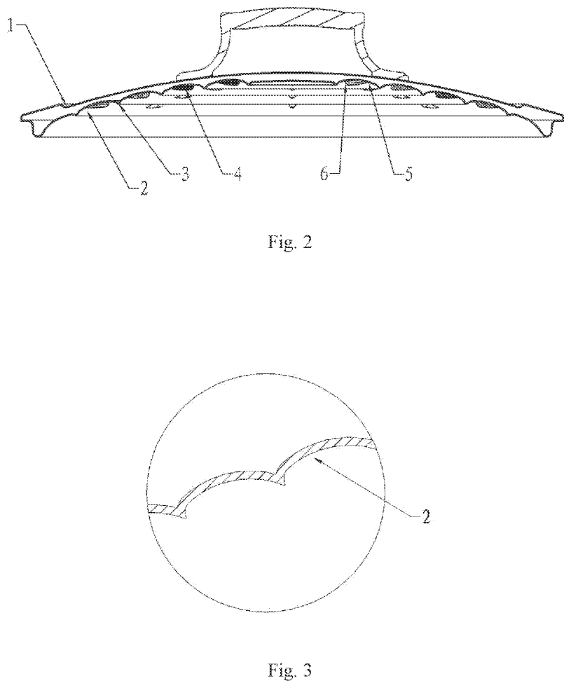

Since the center of the cookware will be heated more during cooking, the water boils faster and produces more steam. The airflow of steam generally rises from the center of the lid 1 and then diffuses to the edge, that is, the steam usually spreads along the radial direction of the lid from the center to the edge. In order to trap the steam along the curved groove surface 2 as much as possible, the curved groove surface 2 needs to be designed accordingly. Specifically, the curvature of each curved groove surface 2 gradually increases from the center of the lid 1 outward along the radial direction, refer to FIG. 3. Such design lets the steam to form a stronger vortex and be trapped in the curved groove surface 2 during the diffusion process, and further lets the steam in each curved groove surface 2 to fully contact with the curved groove surface 2 and condenses. In addition, the arc-shaped groove surface 2 is annularly arranged along the radial direction of the lid 1, so that the steam can be trapped into the ring of the curved groove surface 2 more effectively.

In order to ensure that the steam can be fully condensed and collected, the number of curved groove surfaces 2 is two or more, and the radially adjacent curved groove surfaces 2 are connected by the protrusion part 3. The number and position of the curved groove surfaces can be set according to actual needs.

In order to further enhance the directional condensation and collection of steam, the convex block 4 for guiding the steam condensing direction is also added in the curved groove surface 2. The convex block 4 is provided with small diameter ends 5 and the large diameter end 6 in lateral direction. The larger diameter end 6 faces the center of the lid and the small diameter end 5 is set far from the center of the lid. Because the surface area of the large diameter end 6 is larger, the flow rate of steam here is faster, and the temperature drop is slower. While the surface area of the small diameter end 5 is smaller, the flow rate of water vapor here becomes slower, and the temperature decreases faster and the condensation is easier, so the convex block 4 can further guide the steam to condense along the direction of the convex block 4.

Similarly, the lateral direction of the convex block 4 is arranged along the radial direction of the lid 1 for adapting to the flow direction of steam. In addition, the surfaces of the small diameter end 5 and the large diameter end 6 are curved surfaces to reduce the generation of turbulence and maintain the vortex of the steam in the curved groove surface 2. Correspondingly, a number of the convex blocks 4 are evenly arranged in each curved groove surfaces 2, and the position and number of the convex blocks 4 can be set accordingly according to the needs of use.

In order to improve the heat preservation of the cookware and prevent the user from accidentally touching the outer surface of the cookware lid 1 and may be scalded, the cookware lid is composed of the outer layer and the inner layer, so as to form an insulating interlayer between. The heat of the inner layer can only be transferred to the outer layer by conduction through the connection place between the inner layer and the outer layer. As the area of the connection is small, the heat transferred from the inner layer to the outer layer is limited, and it is easily diffused to the environment. So that the temperature of the outer layer is kept low to prevent scalding, and the heat in the cookware is not easily lost through the lid of the cookware, which has a good energy-saving effect. Specifically, the outer layer and the inner layer are welded as a whole, and the welding seam can be eliminated by grinding and polishing to keep good appearance.

1. A steam directional condensation structure of lid, wherein the internal side of the lid provides with a curved groove surface for generating steam vortex; along the section of the protrusion part, a protrusion part is provided at one side for conducting the condense droplet back to the cookware; when the steam comes into the curved groove surface, it generates the steam vortex and contacts with the curved groove surface to condense into droplets; droplets flow along the curved groove surface to the protrusion part, gather and drip back into the cookware; the curved groove surface and the protrusion part are arranged in the corresponding position of the lid where liquid droplets need to be condensed.

2. The steam directional condensation structure of lid of claim 1, wherein the curvature of each curved groove surface gradually increases from the center of the lid outward along the radial direction.

3. The steam directional condensation structure of lid of claim 1, wherein the curved groove surface is annularly arranged along the radial direction of the lid.

4. The steam directional condensation structure of lid of claim 2, wherein the number of the curved groove surface is two or more; the adjacent curved groove surfaces are connected by protrusion part along the radial direction.

5. The steam directional condensation structure of lid of claim 1, wherein the curved groove surface is also provided with a convex block for guiding the direction of the steam condensation; the convex block is provided with a small diameter end and a large diameter end in lateral direction, the large diameter end faces the center of the lid.

6. The steam directional condensation structure of lid of claim 5, wherein the lateral direction of the convex block (4) is arranged along the radial direction of the lid.

7. The steam directional condensation structure of lid of claim 5, wherein the surface of the small diameter end and the large diameter end is curved.

8. The steam directional condensation structure of lid of claim 5, wherein a number of the convex blocks are evenly arranged in each curved groove surfaces.

9. The steam directional condensation structure of lid of claim 1, wherein the lid is composed of an outer layer and an inner layer, which an insulating interlayer is formed between.

10. The steam directional condensation structure of lid of claim 9, wherein the outer layer and the inner layer are welded as a whole.
